(19) United States
(12) Patent Application Publication
(10) Pub. No.: US 2008/0156642 A1
(43) Pub. Date: Jul. 3, 2008

(54) System for the Disinfection of Low-Conductivity Liquids

(76) Inventors: Matthias Fryda, Itzehoe (DE); Thorsten Matthee, Hohenaspe (DE)

Correspondence Address: GREENBLUM & BERNSTEIN, P.L.C., 1950 ROLAND CLARKE PLACE, RESTON, VA, 20191, US

(21) Appl. No.: 11/817,655

(22) PCT Filed: Mar. 1, 2006
(86) PCT No.: PCT/DE2006/000369

§ 371 Date: Aug. 31, 2007

(30) Foreign Application Priority Data
Mar. 4, 2005 (DE) 20 2005 003 720.6

(51) Int. Cl. C02F 1/467

(52) U.S. Cl. 204/261

(57) ABSTRACT

A system for the disinfecting of low-conductivity liquids, in particular water, is provided. The system includes an electrochemical cell in which electrodes are arranged such that the liquid flushes or flows around them, and in which oxidizing agents are produced from the liquid by applying a current. A mixing unit is mounted downstream of the electrochemical cell in the flow direction, in which mixing unit the oxidizing agents are intermixed with the liquid.

### CROSS-REFERENCE TO RELATED APPLICATIONS

The present application claims priority under 35 U.S.C. §119 of German Patent Application No. 20 2005 003 720.6, filed on Mar. 4, 2005.

### BACKGROUND OF THE INVENTION

1. Field of the Invention

The invention relates to a system for the disinfection of low-conductivity liquids, in particular water, with an electrochemical cell in which electrodes are arranged such that the liquid flushes or flows around them, and in which oxidizing agents are produced from the liquid by applying a current.

2. Discussion of Background Information

There are diverse methods for the disinfection of small amounts of liquid, i.e., amounts of less than 1000 l/h. These methods are used in particular for drinking water purification, the production of ultra-pure water or the provision of process waters. Disinfecting can be carried out, e.g., by a metered addition of chemicals. These chemicals, however, have to be filtered out of the water flow after exerting the disinfecting effect.

As an alternative to the use of chemicals, a disinfection can be carried out by UV lamps. This leads to an undesired heating of the water, which also requires a high energy expenditure. What is more, the disinfecting effect depends on the water's turbidity and load of particles.

A use of ozone generators with dark discharge requires a dehumidification of the air used. In this process there is also the danger of nitrogen oxide formation.

As an alternative to the use of air, it is possible to use pure oxygen for disinfection. This process, though, is complex in terms of handling and procuring the gases.

Also, electrolytic ozonizers with PbO₂ electrodes pose the danger of a lead contamination of the water. In this process, a high expenditure in terms of instruments and machinery is required, as well.

### SUMMARY OF THE INVENTION

The present invention provides a system that can operate as an independent treatment plant even with small amounts of liquid.

According to the invention, this is attained with the features of claim 1. Advantageous embodiments and further developments of the invention are described in the dependent claims. The system according to the invention provides that a mixing unit is mounted downstream of the electrochemical cell in the flow direction. In the mixing unit oxidizing agents produced in the electrodes are intermixed with the liquid. A maximum of the oxidizing agents, preferably ozone or hydroxyl radicals, is thus dissolved in the liquid, which results in a fast and complete disinfection or decontamination of the liquid, in particular water.

With small electrochemical cells with a throughput of less than 1000 l/h, a reliable sterilization requires a considerable expenditure in terms of machinery. The disinfection unit according to the invention can be embodied as an independent system in which the liquid and the oxidizing agent are intermixed and an improved sterilization thus occurs. This applies in particular to the use of electrochemical cells with electrodes between which a polymer solid-state electrolyte in membrane technology is arranged. The use of electrode arrangements renders possible the disinfection of rainwater, the disinfection of ultra-pure water circuits in the semiconductor industry and pharmaceutical industry or with the removal of organic contamination in rinsing waters, with the purification of water for the food industry and cosmetics industry, which arrangements prevent the algae or bacteria growth through the oxidizing agents produced or, with high contaminations, achieve a degradation. The germs are oxidized by the oxidizing agents and thus killed or inactivated. It is also possible to purify a germ-contaminated system by retrofitting a disinfection unit.

A further development of the invention provides a reaction chamber with an enlarged flow cross-section compared to that of the electrochemical cell or the mixing unit is mounted downstream of the mixing unit in the flow direction. In this arrangement, the exposure time of the oxidizing agents is extended and germ contamination can be better eliminated. The embodiment of the reaction chamber as a separate chamber has the advantage that the flow velocity lessens, and a separate post-treatment of the mixture of liquid and oxidizing agent can occur.

Furthermore, a separating unit is provided for the removal of the oxidizing agent from the liquid. The separating unit is mounted downstream of the mixing unit or also of the reaction chamber in the flow direction. This arrangement is advantageous in particular with the use of drinking water disinfection in order to ensure that no oxidizing agents are left within the drinking water.

UV lamps can be arranged in the separating unit, which irradiate the mixture of liquid and oxidizing agent. Here, it is also possible to use inexpensive UV lamps with a maximum radiation at 254 nm. Such lamps have a relatively low power consumption and work effectively.

Alternatively or additionally, one or more activated carbon filter units can be arranged in the separating unit. These carbon filter units reduce the ozone produced or other substances, e.g., oxychloride, to the legally required value. If the activated carbon filter is composed of at least two stages with different porosity, first the intermixing of the oxidizing agents and the liquid and subsequently the removal of the oxidizing agents can be carried out in the activated carbon filter itself. An intermixing is first carried out beginning with a coarse-grained activated carbon in the flow direction, subsequently the oxidizing agent is removed with fine-grained activated carbon. With an activated carbon filter with a granularity that increases, i.e., becomes finer in the flow direction, the increase can occur in the stages or continuously.

The activated carbon filters can be embodied as an exchangeable filter cartridge, which supports a modular setup of the system.

It is also possible for a catalyst to be present in the separating unit. The oxidizing agent or agents are converted at the catalyst. The use of a catalytically acting platinum sponge is conceivable.

Advantageously, the entire system is manufactured of an ozone-resistant plastic, whereby each component, i.e., the electrochemical cell, the mixing unit, the reaction chamber or the separating unit, is provided with corresponding connecting pieces. A one-piece housing to accommodate the components is preferably made of an injection-molded part, which has advantages in terms of production technology and costs. The components are inserted into the housing.

As the solubility of ozone increases with decreasing temperatures in water, a refrigerating aggregate is provided that cools the liquid or the system components.

An advantageous further development of the invention provides that a power supply unit, the polarity of which can be reversed, is assigned to the electrodes in order to burst off calcifications from the electrodes through a periodic reversal of the polarity. This maintains the effectiveness of the electrodes.

Since the solubility of ozone also increases as the pressure rises, a further development of the invention provides that a restrictor with a narrowed flow cross-section is arranged at the output of the electrochemical cell, in order to increase the pressure within the electrochemical cell. Furthermore, the restrictor or tapering directly behind the electrochemical cell has the advantage that a first intermixing occurs at the restrictor or tapering.

A vertical arrangement of all the components and a flow guidance of the liquid from the bottom upwards have the advantage that the intermixing of the liquid and the oxidizing agent, in particular ozone, is supported by the fact that the gas bubbles strive to rise from the bottom upwards.

For the treatment of low-conductivity liquids, e.g., ultra-pure water, the application of high voltages is required because of the high resistance of water in order to produce the required current densities for the production of the oxidizing agents. A partial solution of this problem is achieved by the use of polymer solid-state electrolytes, which, preferably in the form of a membrane with a thickness of several tenths of a millimeter to several millimeters, bridge the distance between the electrodes because of their ion conductivity. The polymer solid-state electrolytes are suitable as an intermediate layer between the electrodes to prevent a short circuit. Because of the relatively high ion conductivity of the polymer solid-state electrolyte, the electric potential of the one electrode is guided very close to the other electrode. As there is a water film between the surface of the polymer solid-state electrolyte and the directly adjacent electrode, the water film is thus exposed to high current densities.

An advantageous electrode arrangement provides a polymer solid-state electrolyte between the electrodes, whereby the electrodes are pressed against one another by a pressure device and are embodied such that the liquid can flow through them, whereby the pressure device is supported on the electrodes. An electrode arrangement of this type therefore does not require a special housing arrangement with complex pressure plates for pressing the electrodes against the polymer solid-state electrolyte inserted between the electrodes, but requires only a pressure device that is directly connected to the electrodes and derives the pressure force from the rather relatively low mechanical stability of the electrodes. The invention is based on the realization that, in contrast to the perception that has prevailed for decades among those skilled in the art, an effective electrode arrangement can be realized even without a very high contact force of the electrodes against the polymer solid-state electrolyte. For suitable electrodes it is sufficient if only a certain, relatively low pressure force of the electrodes is exerted on the polymer solid-state electrolyte, so that the corresponding pressure force does not have to be produced in a complex manner by specifically constructed housing parts, but can be exerted in a simple manner directly at the electrodes themselves.

For instance, it is thus possible to use an expanded-metal lattice as the base material of an electrode, which lattice is coated, e.g., with a doped diamond layer. It is possible to push a plastic screw through the lattice openings of the expanded-metal lattice until the head of the plastic screw bears against the electrode. The bracing of the two electrodes in the direction of the polymer solid-state electrolyte can then be carried out by screwing a nut onto the shank, which extends through the two electrodes and the polymer solid-state electrolyte located therebetween.

An intensive through-flow of the electrode arrangement can thereby be ensured in that the polymer solid-state electrolyte, preferably embodied in the form of a membrane, has flow-through openings. It is further possible to ensure the through-flow of the gap between the electrodes in that the polymer solid-state electrolyte is arranged in strips spaced apart from one another in the gap between the electrodes. In a further development, the polymer solid-state electrolyte can also be arranged in the gap in surface pieces spaced apart from one another on all sides, so that it is ensured that the gap can be flowed through in different directions.

The polymer solid-state electrolyte can be inserted between the electrodes in the form of a membrane. In particular with the embodiment in the form of surface pieces spaced apart from one another on all sides, however, it will be expedient for the polymer solid-state electrolyte to be applied to one of the electrodes as a surface layer.

Since the electrode arrangement according to the invention does not require a complex generation of contact pressure, it is easily possible to assemble a stack with the electrode arrangement. The stack renders possible an effective electrolysis unit even for higher flow rates. Since the pressure device is supported on the electrodes themselves, it is easily possible to arrange numerous electrodes into a stack with a polymer solid-state electrolyte arranged between them. Thereby, it is particularly expedient for the electrodes to be equipped for electric contacting by contact tabs projecting beyond the common surface of the electrodes. The contact tabs of the anodes in the stack on the one hand and those of the cathodes in the stack on the other hand can thereby be embodied in a manner aligned with one another, in order to simplify a common contacting, e.g., by a contact bar pushed through openings of the contact tabs.

The electrode arrangement according to the invention also makes it possible in a surprisingly simple manner to move away from the flat electrodes hitherto customary. It is thus possible, e.g., to embody two electrodes in a rod-shaped manner and to realize the polymer solid-state electrolyte between the electrodes in that the solid-state electrolyte alternately wraps around the electrodes in the form of a strip under preload. The strip can thereby be mounted wrapping around each of the two electrodes in the form of a figure eight, whereby the wrapping occurs with a certain preload in order to ensure the intimate contact. The two electrodes can be pressed against the strip sections of the polymer solid-state electrolyte located between the electrodes, e.g., by a wire-shaped material wrapped around the electrodes, with the ends twisted together to generate the pressure. The wire-shaped material can thereby preferably be an insulating material or bear against the electrodes via an insulating layer.

### BRIEF DESCRIPTION OF THE DRAWINGS

The invention is explained below in more detail on the basis of exemplary embodiments presented in the drawings. These drawings include:

FIG. 1 shows a diagrammatic representation of the system setup;

FIG. 2 shows an overall view of a disinfection unit;

FIG. 3 shows a diagrammatic representation of two electrodes and a membrane from a solid-state electrolyte arranged between them;

FIG. 4 shows a stack formed of the arrangement according to FIG. 3;

FIG. 5 shows a perspective representation of the stack according to FIG. 4;

FIG. 6 shows a further embodiment of two electrodes with a solid-state electrolyte in the form of strips arranged parallel to one another;

FIG. 7 shows a top view of a stack formed of the arrangement according to FIG. 6, in which stack each electrode is contacted;

FIG. 8 shows a stack formed of the arrangement according to FIG. 6 with a contacting of the outer electrodes only;

FIG. 9 shows a variant of the arrangement according to FIG. 6, in which the electrode plates are provided with slot-shaped through holes;

FIG. 10 shows a stack formed of the arrangement according to FIG. 9;

FIG. 11 shows an arrangement of two electrodes, one of which is coated on its surface facing the other electrode with applied surface sections of the polymer solid-state electrolyte;

FIG. 12 shows a stack formed of the arrangement according to FIG. 11;

FIG. 13 shows a perspective representation similar to FIG. 5 with contact tabs on the differently polarized electrodes;

FIG. 14 shows a diagrammatic representation of a treatment cell loaded with an electrode stack; and

FIG. 15 shows a view of an electrode arrangement with two rod-shaped electrodes.

### DETAILED DESCRIPTION OF THE PRESENT INVENTION

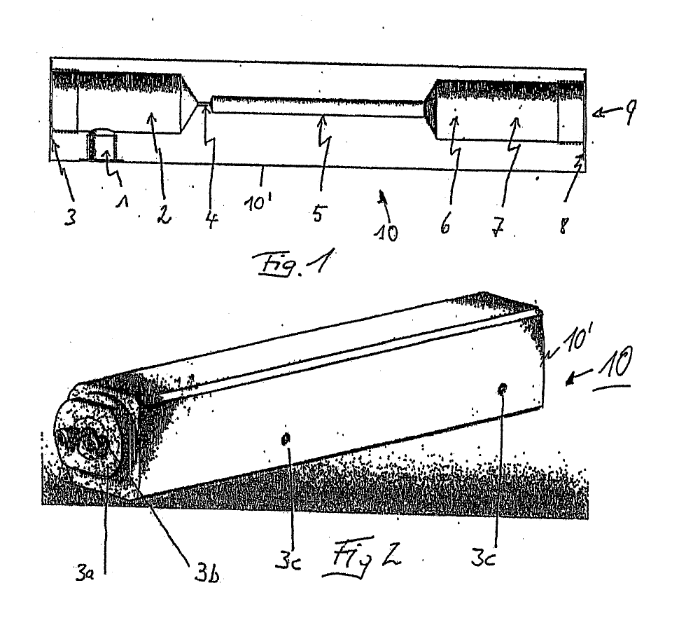

FIG. 1 shows a basic system setup of a disinfection unit 10 with an inlet 1 through which the liquid to be disinfected, preferably water, is guided into an electrode-accommodating chamber 2. On the front face, the electrode-accommodating chamber 2 has a gasket surface 3 to accommodate an electrode pad 3a, as shown in FIG. 2. FIG. 2 shows the disinfection unit 10 from the outside in an overall view. Sockets 3b for the electrical connection from outside are provided on one electrode pad 3a. Bores 3c are provided in the housing 10′ that is embodied in one piece, preferably manufactured of ozone-resistant plastic, for a fastening device of the total system 10 at the designated place of use.

The liquid flows around the electrodes within the electrode-accommodating chamber 2 embodied or arranged in the housing 10′, and an oxidizing agent, preferably ozone, is produced from the liquid. This ozone, together with the inserted liquid, is guided through a restrictor point 4 in the form of a cross-sectional tapering into a mixing unit 5, which causes a first intermixing. The mixing unit 5, embodied as a static mixer, is used for the intensive intermixing of the oxidizing agent and the liquid and opens into a retention chamber or reaction chamber 6 mounted downstream in the flow direction. The reaction chamber 6 has an enlarged flow cross-section compared to the mixing unit 5, which causes the flow velocity of the liquid with the oxidizing agent dissolved or held therein to slow down.

The increased flow velocity in the mixing unit 5 has the advantage that the ozone dissolves better in the water. The lowering of the flow velocity in the retention chamber and reaction chamber 6 allows the oxidizing agent to become active within the liquid and to kill germs or remove contamination.

An accommodation chamber 7 for a separating unit is mounted downstream of the retention chamber and reaction chamber 6. In the separating unit 7 the supplied oxidizing agent dissolved in the liquid is removed from the liquid. This can be carried out, e.g., by activated carbon filters, UV irradiation or catalytic elements or a combination thereof.

A gasket surface 8 for a lid is embodied at the frontal end of the separating unit 7. An outlet 9 is embodied in the lid 8, through which outlet the disinfected liquid, preferably water, can be discharged. The components 2, 4, 5, 6, 7 can be arranged in the housing 10′ as required and assembled to form a compact disinfection unit 10. The subsequent figures show the special setup of the electrodes used with the invention.

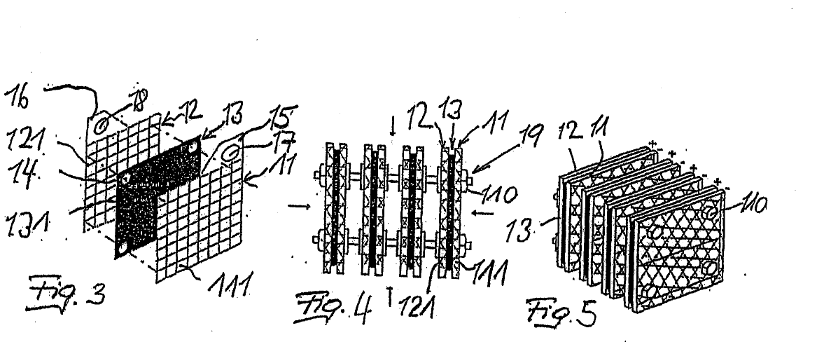

FIG. 3 shows two electrodes 11, 12 in the form of expanded-metal lattices 111, 121. A first electrode 11 serves as a cathode, whereas the second electrode 12 acts as an anode. Both electrodes 11, 12 are embodied in a flat manner with a rectangular cross section and have the same surface shape. A polymer solid-state electrolyte 13 in the form of a membrane 131 is located between the two electrodes 11, 12. The surface of the membrane 131 corresponds to the surface of the electrodes 11, 12. The membrane 131 is provided with a through hole 14 in each of its four corner areas. The membrane 131 has a thickness of, e.g., between 0.4 and 0.8 mm.

Outside of the rectangular surface of the expanded-metal lattices 111, 121, the electrodes 11, 12 are respectively provided with a contact tab 15, 16 projecting out of the surface. Both contact tabs 15, 16 have a through hole 17, 18.

FIG. 4 illustrates that the electrodes 11, 12 formed of the expanded-metal lattices 111, 121 and with respectively one solid-state electrolyte 13 lying between them are pressed against one another by a clamping device 19. The clamping device 19 extends over four electrode arrangements 11, 12, 13 assembled to form a stack. The bracing is carried out by nuts 110 which can be braced against the electrodes 11, 12 on the clamping device, e.g., stud bolt 19.

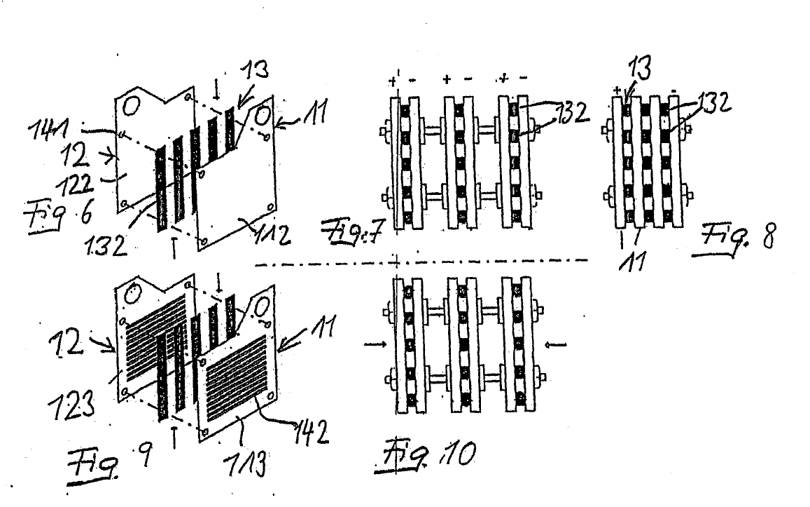

According to FIG. 5, four stud bolts 19 are pushed through the gaps of the expanded-metal lattices 11, 21 and through the through holes 4 of the polymer solid-state electrolyte 13. FIG. 5 also illustrates in a perspective representation that the electrodes 11, 12 are respectively connected to different poles of the supply voltages. In the exemplary embodiment represented in FIGS. 3 through 5, the electrodes 11, 12 are formed with a base in the form of an expanded-metal lattice 111, 121 and coated with a doped diamond layer. It is also possible to apply supply voltages of different sizes to the electrodes 11, 12.

FIG. 6 shows a modified exemplary embodiment in which the electrodes 11, 12 are formed with metal plates 112, 122 that are coated with a doped diamond layer. The electrodes have through holes 141 in their corner areas, through which holes stud bolts 19 can be pushed in the manner described with reference to FIGS. 4 and 5.

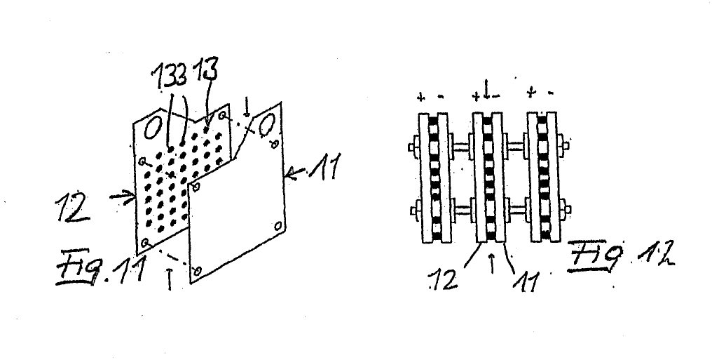

In this exemplary embodiment, the polymer electrolyte 13 is formed by vertically upright strips 132 arranged in parallel with a spacing from one another. The top view of FIG. 7 illustrates that the electrode arrangements in the stack formed can be flowed through perpendicular to the drawing plane because of the strips 132.

The stack arrangement shown in FIG. 8 is composed of four equal electrodes 11 that are separated from one another by respectively one solid-state electrolyte 13, here in the form of the strips 132. The contacting takes place with different polarities merely at the two outer electrodes 11, whereby the middle electrodes assume correspondingly graded potentials. An arrangement of this type, in which the middle electrodes act both as an anode (to the one side) and as a cathode, is also called a bipolar arrangement.

The exemplary embodiment represented in FIG. 9 differs from the exemplary embodiment according to FIG. 6 merely in that metallic plates 113, 123 are used as bases of the electrodes 11, 12. The plates 113, 123 are provided with horizontal slot-shaped through holes 142 that render possible a through-flow of the electrodes 11, 12. Accordingly, the arrows in FIG. 10 show that a through-flow of the electrode arrangements in the stack direction is possible in addition to the vertical through-flow (perpendicular to the drawing plane).

In the exemplary embodiment shown in FIG. 11, the polymer solid-state electrolyte 13 is applied in the form of circular surface sections 133 to the surface of the second electrode 12 facing the first electrode 11. The polymer electrolyte 13 is thus laminated directly onto the electrode 12. The top view of a multiple electrode arrangement in FIG. 12 shows that the gap between the electrodes 11, 12 can be flowed through horizontally and vertically, since the surface sections 133 are spaced apart from one another on all sides, which results in flow-through areas in the spacings.

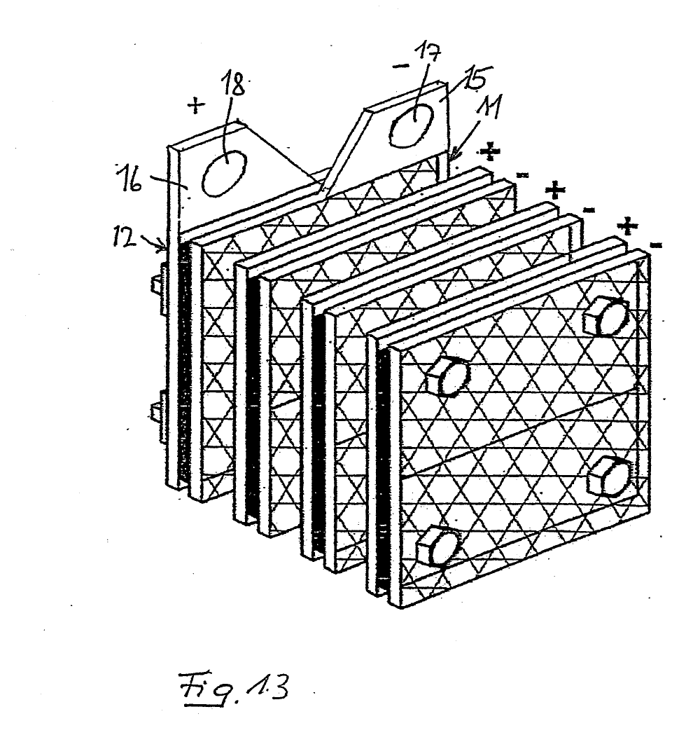

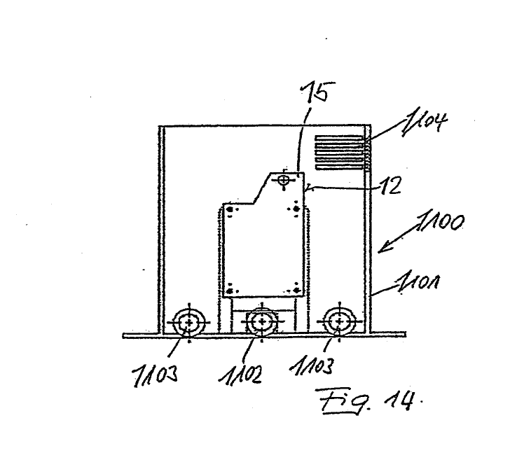

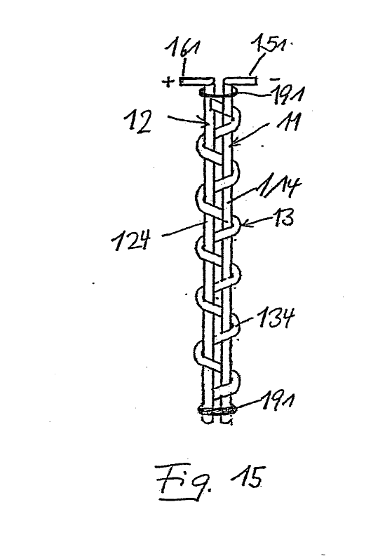

In an enlarged diagrammatic representation, FIG. 13 illustrates the contacting of the electrodes 11, 12 by the contact tabs 15, 16 and the through holes 17, 18 located therein. The contact tabs 15, 16 of the respectively homopolar electrodes 11, 12 are aligned with one another (FIG. 13 depicts the contact tabs 15, 16 only for the two rear electrodes 11, 12 of the stack). The contact tabs 15 of the first electrodes 11 can be contacted to one another by a contact stud (not shown) pushed through the through holes 17 aligned with one another, and can thus be connected jointly with one pole of the supply voltage. The contacting of the other electrodes 12 occurs in the same manner via the contact tabs 16 and the through holes 18 aligned with one another located therein.

FIG. 14 illustrates the setup of a treatment cell 1100. In this illustration only the anodes 12 of the electrode arrangements are shown for the sake of clarity, which anodes are contacted via their contact tabs 15 aligned with one another. The cell 1100 has a housing 1101 that has an inlet opening 1102 for the water to be purified. In the housing 1101, the water to be purified flows from the bottom upwards into the area of the electrodes 12 and exits the area of the electrodes at the side, in order to leave the housing 1101 in a purified state via the outlet openings 1103. Ventilation slots 1104 are located in the top area of the housing 1101.

FIG. 15 shows a different arrangement of the electrodes 11, 12, embodied in this exemplary embodiment as rod-shaped electrodes 114, 124. The solid-state electrolyte 13 serves as a spacer between the electrodes 11, 12. The electrolyte is shaped as a long strip 34 and forms a figure “eight” in a meandering manner. The electrolyte wraps around the electrodes 11, 12 with a preload so that the strip 134 already draws the electrodes 11, 12 against one another. The electrodes are pressed against one another or against the sections of the solid-state electrolyte 13 located between them by two loops 191 placed around the electrodes 11, 12 and made of a wire-shaped insulating material. The loops can be drawn together by twisted ends, so that the electrodes 11, 12 are thus drawn against one another.

The contacting of the electrodes 11, 12 occurs at frontal ends with contact pieces 151, 161. An embodiment of this type of the electrode arrangement is suitable in particular for water purification in pipe systems.

1. A system for the disinfection of low-conductivity liquids, comprising:
an electrochemical cell in which electrodes are arranged such that the liquid flushes or flows around the electrods, and in which oxidizing agents are produced from the liquid by applying a current;
a mixing unit mounted downstream of the electrochemical cell in a flow direction, the oxidizing agents are intermixed with the liquid in the mixing unit;
a polymer solid-state electrolyte arranged between the electrodes; and
a pressure device pressing the electrodes against one another and being supported by the electrodes, the pressure device being embodied such that the liquid flow through the pressure device them.

2. The system according to claim 1, further comprising a reaction chamber with a flow cross-section that is enlarged compared to that of the electrochemical cell or the mixing unit the reaction chamber being mounted downstream of the mixing unit in the flow direction.

3. The system according to claim 1, further comprising a separating unit for the separation of the oxidizing agents from the liquid, and mounted downstream of the mixing unit or of the reaction chamber in the flow direction.

4. The system according to claim 3, further comprising UV lamps arranged in the separating unit, which irradiate the mixture of liquid and oxidizing agents.

5. The system according to claim 4, further comprising at least one activated carbon filter arranged in the separating unit.

6. The system according to claim 5, wherein the activated carbon filter is composed of two stages with different porosity.

7. The system according to claim 5, wherein the activated carbon filter is embodied as an exchangeable filter cartridge.

8. The system according to claim 5, wherein the activated carbon filter is embodied as a mixture unit with a granularity that becomes finer in the flow direction.

9. The system according to claim 3, wherein the separating unit has a catalyst at which the oxidizing agent is converted.

10. The system according to claim 1, further comprising one of a power supply unit, the polarity of which can be reversed, power supply unit being assigned to the electrodes and the at least one electrode has a base made of metal

11. The system according to claim 1, further comprising a refrigerating aggregate is provided that cools the liquid and/or the system components.

12. The system according to claim 1, further comprising a restrictor with a flow cross-section that is reduced with respect to a flow cross-section of the electrochemical cell being arranged at the output of the electrochemical cell.

13. The system according to claim 1, wherein at least the electrochemical cell and mixing unit are arranged such that there is a vertical flow direction of the liquid from bottom upwards.

14. (canceled)

15. The system according to claim 1, wherein at least one electrode has a base coated with a doped diamond layer.

16. (canceled)

17. The system according to claim 10, wherein the base is formed by an expanded-metal lattice.

18. The system according to claim 17, wherein:
the electrodes have through holes to the polymer solid-state electrolyte; and
the solid-state electrolyte has through holes.

19. (canceled)

20. The system according to claim 18, wherein the polymer solid-state electrolyte fills a gap between the electrodes only in part.

21. The system according to claim 20, wherein the polymer solid-state electrolyte is arranged in strips spaced apart from one another in the gap between the electrodes.

22. The system according to claim 21, wherein the polymer solid-state electrolyte is arranged in surface pieces spaced apart from one another on all sides in the gap between the electrodes.

23. The system according to claim 22, wherein the polymer solid-state electrolyte is applied as a surface layer on one of the electrodes.

24. The system according to claim 23, further comprising an arrangement formed of a stack of several electrodes and several polymer solid-state electrolytes arranged respectively between the electrodes, which are jointly pressed against one another by the pressure device.

25. The system according to claim 24, further comprising several individual arrangements formed of respectively two electrodes and a polymer solid-state electrolyte joined into a stack by the pressure device and the electrodes are embodied in a flat manner.

26. (canceled)

27. The system according to claim 25, wherein the pressure device of several screw joints guided through the electrodes and made of insulating material.

28. The system according to claim 27, wherein the pressure device is formed by a wire-shaped material wrapped around the electrodes with ends twisted with one another to generate the pressure.

29. The system according to claim 28, wherein the electrodes are two electrodes are embodied in a rod-shaped manner, and that the polymer solid-state electrolyte alternately wraps around the two electrodes in the form of a strip under preload.
